(19) United States
(12) Patent Application Publication
(10) Pub. No.: US 2007/0280433 A1
(43) Pub. Date: Dec. 6, 2007

(54) Voicemail message controls

(75) Inventors: David Milstein, Redmond, WA (US); David A. Howell, Seattle, WA (US); Kuansan Wang, Bellevue, WA (US); Linda Criddle, Kirkland, WA (US); Lon-Chan Chu, Redmond, WA (US); Michael D. Malueg, Renton, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Microsoft Corporation, Redmond, WA (US)

(21) Appl. No.: 11/444,633

(22) Filed: May 31, 2006

(51) Int. Cl. H04M 1/64

(52) U.S. Cl. 379/67.1

(57) ABSTRACT

Generally described, aspects of the present invention are directed at software systems for responding to a received voicemail message. In one embodiment, a selection user interface is provided where a primary callee may generate an event to create a draft voicemail message that is related to a received voicemail message. In response to receiving an event from the selection user interface to create a draft voicemail message, aspects of the present invention (1) create an electronic file to store the draft voicemail message, and (2) insert metadata into the electronic file that defines the relationship between the draft voicemail message and the received voicemail message. As a result, a callee may easily create a draft voicemail message that is related to a received voicemail message and have the draft voicemail message automatically populated with contextual data.

### BACKGROUND

Generally described, an Internet telephony system provides an opportunity for users to have a call connection with enhanced calling features compared to a conventional telephony system. In a typical Internet telephony system, often referred to as Voice over Internet Protocol (VoIP), audio information is processed into a sequence of data blocks, called packets, for communications utilizing an Internet Protocol (IP) data network. During a VoIP call conversation, the voice is converted into small frames of voice data according to a network layer protocol used in the IP data network and a voice data packet is assembled by adding an IP header to the frame of voice data that is transmitted and received.

A typical Internet telephony system may include a voicemail system that allows a caller to leave a voicemail message for a callee. However, a callee who receives a voicemail message is not able to easily create and send a new voicemail message that is related to the received voicemail message. Instead, the callee may be required to repetitively input data to create the new voicemail messages even though the data could be identified automatically.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

Generally described, aspects of the present invention are directed at software systems for responding to a received voicemail message. In one embodiment, a selection user interface is provided where a primary callee may generate an event to create a draft voicemail message that is related to a received voicemail message. In response to receiving an event from the selection user interface to create a draft voicemail message, aspects of the present invention (1) create an electronic file to store the draft voicemail message, and (2) insert metadata into the electronic file that defines the relationship between the draft voicemail message and the received voicemail message. As a result, a callee may easily create a draft voicemail message that is related to a received voicemail message and have the draft voicemail message automatically populated with contextual data.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram illustrative of a VoIP environment for establishing a conversation channel between various clients in accordance with an aspect of the present invention;

FIG. 2 is a block diagram illustrative of a VoIP client in accordance with an aspect of the present invention;

FIG. 3 is a block diagram illustrative of various components associated with a VoIP device in accordance with an aspect of the present invention;

FIGS. 4A and 4B are block diagrams illustrative of the exchange of data between two VoIP clients over a conversation channel in accordance with an aspect of the present invention;

FIG. 5 is a block diagram of a data packet used over a communication channel established in the VoIP environment of FIG. 1;

FIG. 6 is a block diagram illustrating interactions between two VoIP clients for transferring contextual information defined by identified structured hierarchies in accordance with an aspect of the present invention;

FIGS. 7A-7C are block diagrams illustrative of interactions among VoIP entities in the VoIP environment utilizing data packet prioritization in accordance with an embodiment of the present invention;

FIGS. 8-12 are block diagrams illustrative of various attribute and classes of structured hierarchies corresponding to VoIP contextual information in accordance with an aspect of the present invention;

FIG. 13 is a pictorial depiction of an exemplary selection user interface with controls for creating a draft voicemail message that is related to a received voicemail message;

FIG. 14 is a flow diagram of a creation routine that creates a draft voicemail message based on input received from a primary callee; and

FIG. 15 is a pictorial depiction of an exemplary update user interface suitable to obtain event data from a primary callee in accordance with one embodiment of the present invention.

### DETAILED DESCRIPTION

In accordance with one embodiment, the present invention provides a user interface that includes controls (e.g., buttons, menu items, etc.) for creating and sending a voicemail message that is related to a received voicemail message. As described in further detail below, voicemail messages received by a callee may be accessed from the user interface. By selecting a received voicemail message and activating the appropriate control, a draft voicemail message that is a “reply,” “forward,” or “reply to all” to the selected voicemail message may be created. Although the present invention will be described in connection with an IP telephony environment, it is equally applicable to any type of digital data exchange that includes audio. Accordingly, the disclosed embodiments and examples are illustrative in nature and should not be construed as limiting.

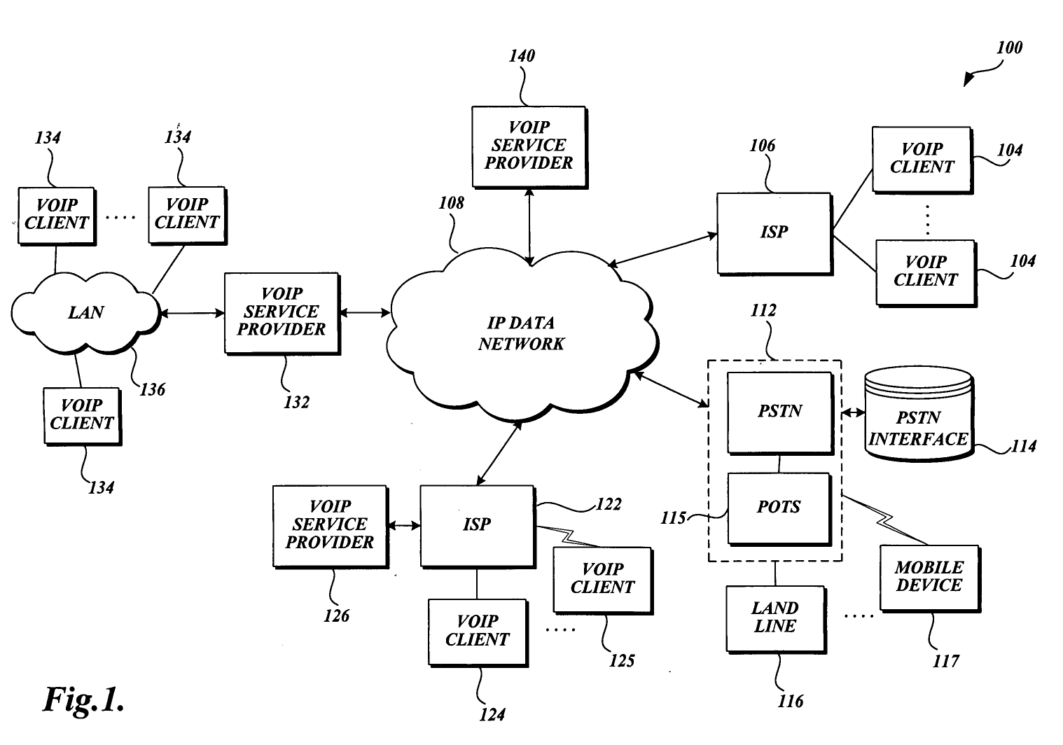

With reference to FIG. 1, a block diagram of an IP telephony environment 100 for providing IP telephone services between various “VoIP clients” is shown. A “VoIP client,” as used herein, refers to a particular contact point, such as an individual, an organization, a company, etc., one or more associated VoIP devices and a unique VoIP client identifier. For example, a single individual, five associated VoIP devices and a unique VoIP client identifier collectively makeup a VoIP client. Similarly, a company including five hundred individuals and over one thousand associated VoIP devices may also be collectively referred to as a VoIP client and that VoIP client may be identified by a unique VoIP client identifier. Moreover, VoIP devices may be associated with multiple VoIP clients. For example, a computer (a VoIP device) located in a residence in which three different individuals live, each individual associated with separate VoIP clients, may be associated with each of the three VoIP clients. Regardless of the combination of devices, the unique VoIP client identifier may be used within a voice system to reach the contact point of the VoIP client.

Generally described, the IP telephony environment 100 may include an IP data network 108 such as the Internet, an intranet network, a wide area network (WAN), a local area network (LAN) and the like. The IP telephony environment 100 may further include VoIP service providers 126, 132 providing VoIP services to VoIP clients 124, 125, 134. A VoIP call conversation may be exchanged as a stream of data packets corresponding to voice information, media information, and/or contextual information. As will be discussed in greater detail below, the contextual information includes metadata (information of information) relating to the VoIP conversation, the devices being used in the conversation, the contact point of the connected VoIP clients, and/or individuals that are identified by the contact point (e.g., employees of a company).

The IP telephony environment 100 may also include third party VoIP service providers 140. The VoIP service providers 126, 132, 140 may provide various calling features, such as incoming call-filtering, text data, voice and media data integration, and the integrated data transmission as part of a VoIP call conversation. VoIP clients 104, 124, 125, 136 may create, maintain, and provide information relating to predetermined priorities for incoming calls. In addition, the VoIP service providers 126, 132, 140 may also generate, maintain, and provide a separated set of priority information (e.g., provider priority list) for individuals communicating in a call conversation. The VoIP service providers 126, 132, 140 may determined and assign an appropriate priority level to data packets based on priority information provided by VoIP clients 104, 124, 125, 136 in conjunction with the provider priority list.

VoIP service providers 132 may be coupled to a private network such as a company LAN 136, providing IP telephone services (e.g., internal calls within the private network, external calls outside of the private network, and the like) and multimedia data services to several VoIP clients 134 communicatively connected to the company LAN 136. Similarly, VoIP service providers, such as VoIP service provider 126, may be coupled to Internet Service Provider (ISP) 122, providing IP telephone services and VoIP services for clients of the ISP 122.

In one embodiment, one or more ISPs 106, 122 may be configured to provide Internet access to VoIP clients 104, 124, 125 so that the VoIP clients 104, 124, 125 can maintain conversation channels established over the Internet. The VoIP clients 104, 124, 125 connected to the ISP 106, 122 may use wired and/or wireless communication lines. Further, each VoIP client 104, 124, 125, 134 can communicate with Plain Old Telephone Service (POTS) 115 communicatively connected to a PSTN 112. A PSTN interface 114 such as a PSTN gateway may provide access between PSTN and the IP data network 108. The PSTN interface 114 may translate VoIP data packets into circuit switched voice traffic for PSTN and vice versa. The PSTN 112 may include a land line device 116, a mobile device 117, and the like.

Conventional voice devices such as land line 116 may request a connection with the VoIP client based on the unique VoIP identifier of that client and the appropriate VoIP device associated with the VoIP client, will be used to establish a connection. In one example, an individual associated with the VoIP client may specify which devices are to be used in connecting a call based on a variety of conditions (e.g., connection based on the calling party, the time of day, etc.).

It is understood that the above mentioned configuration in the environment 100 is merely exemplary. It will be appreciated by one of ordinary skill in the art that any suitable configurations with various VoIP entities can be part of the environment 100. For example, VoIP clients 134 coupled to LAN 136 may be able to communicate with other VoIP clients 104, 124, 125, 134 with or without VoIP service providers 132 or ISP 106, 122. Further, an ISP 106, 122 can also provide VoIP services to its client.

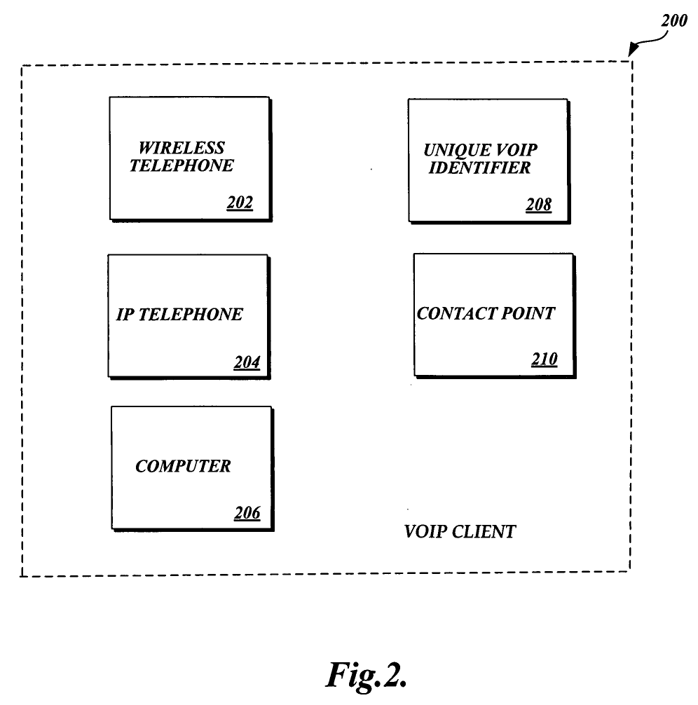

Referring now to FIG. 2, a block diagram illustrating an exemplary VoIP client 200 that includes several VoIP devices and a unique VoIP identifier, in accordance with an embodiment of the present invention, is shown. Each VoIP device 202, 204, 206 may include a storage that is used to maintain voice messages, address books, client specified rules, priority information related to incoming calls, etc. Alternatively, or in addition thereto, a separate storage, maintained for example by a service provider, may be associated with the VoIP client and accessible by each VoIP device that contains information relating to the VoIP client. In an embodiment, any suitable VoIP device such as a wireless phone 202, an IP phone 204, or a computer 206 with proper VoIP applications may be part of the VoIP client 200. The VoIP client 200 also maintains one or more unique VoIP identifier 208. The unique VoIP identifier(s) 208 may be constant or change over time. For example, the unique identifier(s) 208 may change with each call. The unique VoIP identifier is used to identify the client and to connect with the contact point 210 associated with the VoIP client. The unique VoIP identifier may be maintained on each VoIP device included in the VoIP client and/or maintained by a service provider that includes an association with each VoIP device included in the VoIP client. In the instance in which the unique VoIP identifier is maintained by a service provider, the service provider may include information about each associated VoIP device and knowledge as to which device(s) to connect for incoming communications. In alternative embodiment, the VoIP client 200 may maintain multiple VoIP identifiers. In this embodiment, a unique VoIP identifier may be temporarily assigned to the VoIP client 200 for each call session.

The unique VoIP identifier may be used similar to a telephone number in PSTN. However, instead of dialing a typical telephone number to ring a specific PSTN device, such as a home phone, the unique VoIP identifier is used to reach a contact point, such as an individual or company, which is associated with the VoIP client. Based on the arrangement of the client, the appropriate device(s) will be connected to reach the contact point. In one embodiment, each VoIP device included in the VoIP client may also have its own physical address in the network or a unique device number. For example, if an individual makes a phone call to a POTS client using a personal computer (VoIP device), the VoIP client identification number in conjunction with an IP address of the personal computer will eventually be converted into a telephone number recognizable in PSTN.

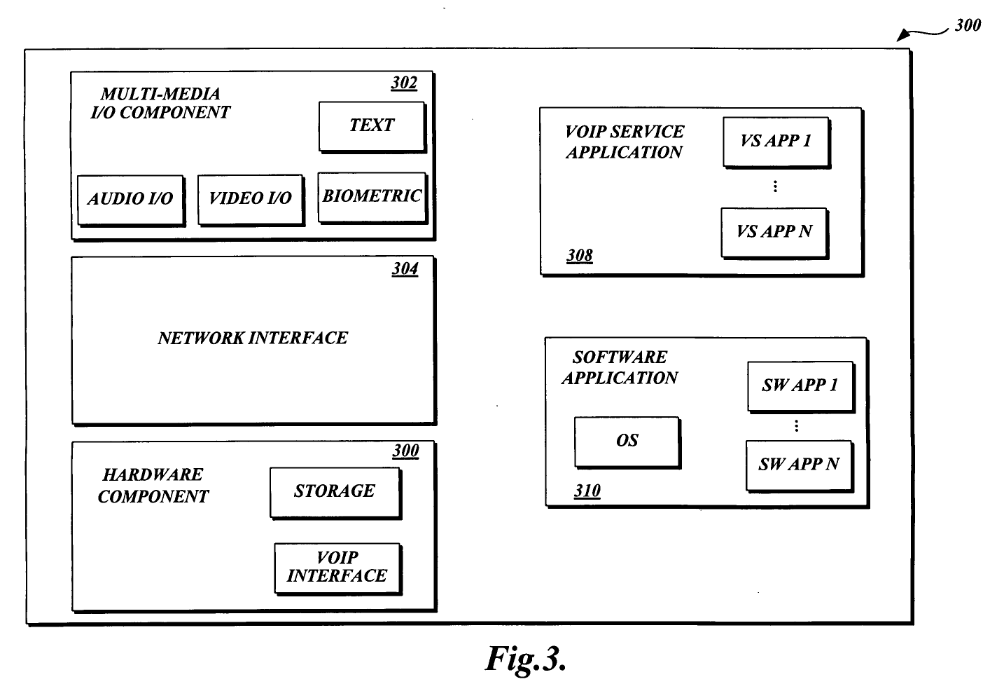

FIG. 3 is a block diagram of a VoIP device 300 that may be associated with one or more VoIP clients and used with embodiments of the present invention. It is to be noted that the VoIP device 300 is described as an example. It will be appreciated that any suitable device with various other components can be used with embodiments of the present invention. For utilizing VoIP services, the VoIP device 300 may include components suitable for receiving, transmitting and processing various types of data packets. For example, the VoIP device 300 may include a multimedia input/output component 302 and a network interface component 304. The multimedia input/output component 302 may be configured to input and/or output multimedia data (including audio, video, and the like), user biometrics, text, application file data, etc. The multimedia input/output component 302 may include any suitable user input/output components such as a microphone, a video camera, a display screen, a keyboard, user biometric recognition devices and the like. The multimedia input/output component 302 may also receive and transmit multimedia data via the network interface component 304. The network interface component 304 may support interfaces such as Ethernet interfaces, frame relay interfaces, cable interfaces, DSL interfaces, token ring interfaces, radio frequency (air interfaces), and the like. The VoIP device 300 may comprise a hardware component 306 including permanent and/or removable storage such as read-only memory devices (ROM), random access memory (RAM), hard drives, optical drives, and the like. The storage may be configured to store program instructions for controlling the operation of an operating system and/or one or more applications and to store contextual information related to individuals (e.g., voice profiles, user biometrics information, etc.) associated with the VoIP client in which the device is included. In one embodiment, the hardware component 306 may include a VoIP interface card which allows non-VoIP client device to transmit and receive a VoIP conversation.

The device 300 may further include a software application component 310 for the operation of the device 300 and a VoIP Service application component 308 for supporting various VoIP services. The VoIP service application component 308 may include applications such as data packet assembler/disassembler applications, a structured hierarchy parsing application, audio Coder/Decoder (CODEC), video CODEC and other suitable applications for providing VoIP services. The CODEC may use voice profiles to filter and improve incoming audio.

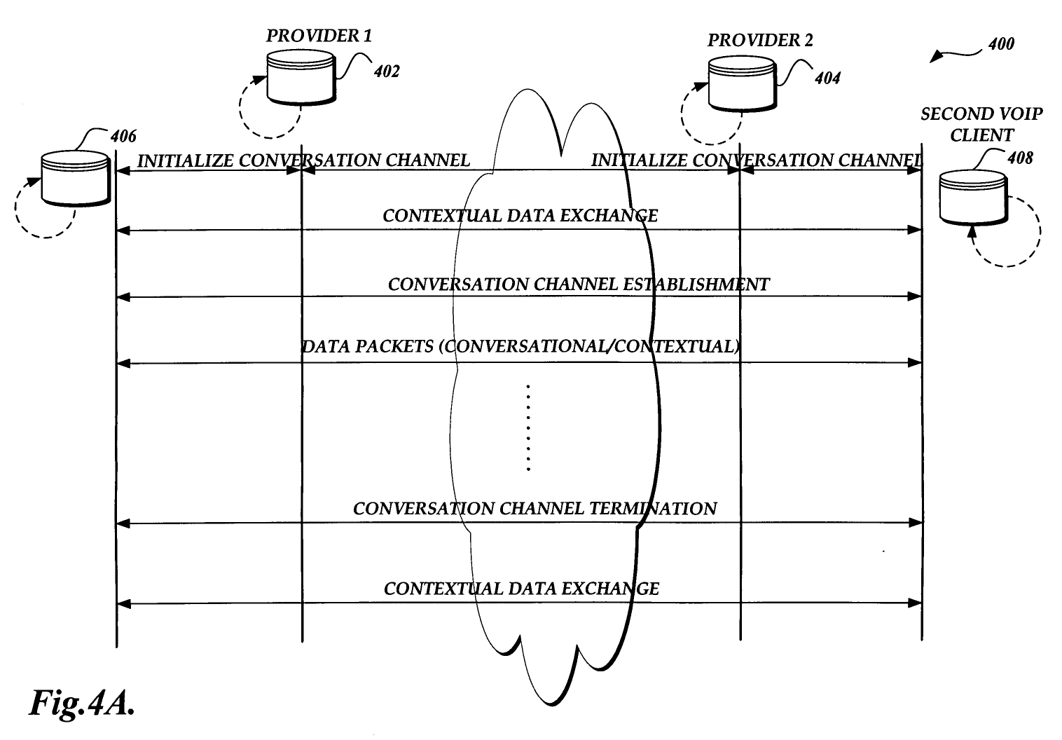

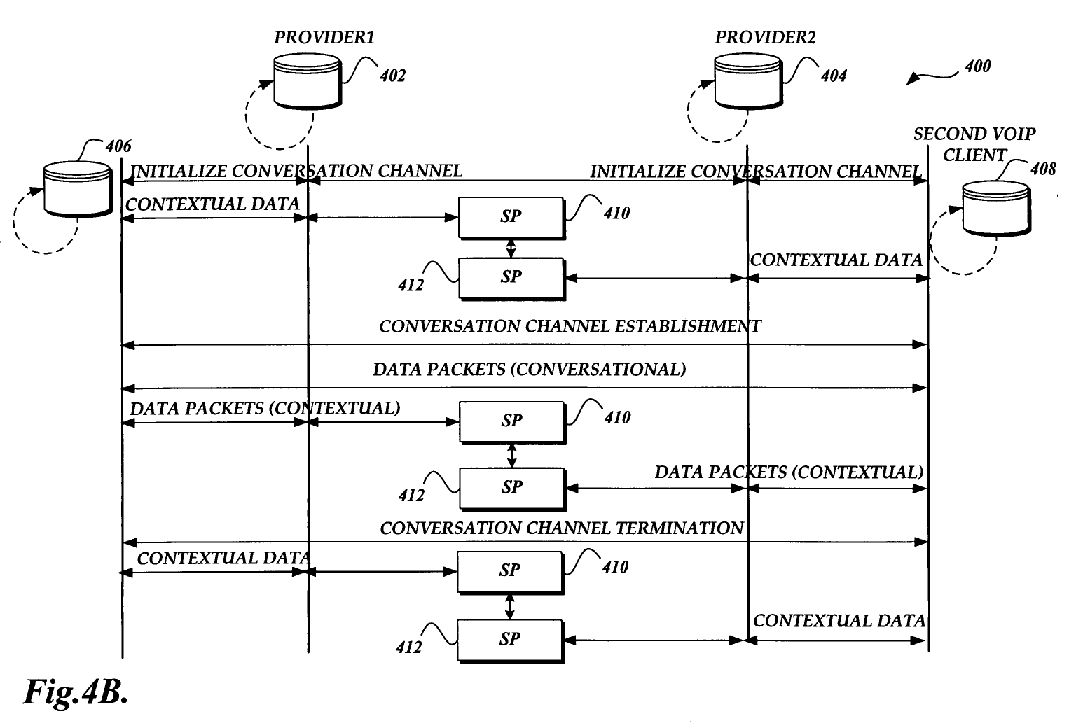

With reference to FIG. 4A, a block diagram illustrative of a conversation flow 400 between VoIP devices of two different VoIP clients over a conversation channel, in accordance with an embodiment of the present invention, is shown. During a connection set-up phase, a VoIP device of a first VoIP client 406 requests to initiate a conversation channel with a second VoIP client 408. In an illustrative embodiment, a VoIP service provider 402 (Provider 1) for the first VoIP client 406 receives the request to initiate a conversation channel and forwards the request to a VoIP service provider 404 (Provider 2) for the second VoIP client 406. While this example utilizes two VoIP service providers and two VoIP clients, any number and combination of VoIP clients and/or service providers may be used with embodiments of the present invention. For example, only one service provider may be utilized in establishing the connection. In yet another example, communication between VoIP devices may be direct, utilizing public and private lines, thereby eliminating the need for a VoIP service provider. In a peer to peer context, communication between VoIP devices may also be direct without having any service providers involved.

There are a variety of protocols that may be selected for use in exchanging information between VoIP clients, VoIP devices, and/or VoIP service providers. For example, when Session Initiation Protocol (SIP) is selected for a signaling protocol, session control information and messages will be exchanged over a SIP signaling path/channel and media streams will be exchanged over Real-Time Transport Protocol (RTP) path/channel. For the purpose of discussion, a communication channel, as used herein, generally refers to any type of data or signal exchange path/channel. Thus, it will be appreciated that depending on the protocol, a connection set-up phase and a connection termination phase may require additional steps in the conversation flow 400.

For ease of explanation, we will utilize the example in which both the first VoIP client 406 and the second VoIP client 408 each only includes one VoIP device. Accordingly, the discussion provided herein will refer to connection of the two VoIP devices. The individual using the device of the first VoIP client 406 may select or enter the unique VoIP identifier of the client that is to be called. Provider 1 402 receives the request from the device of the first VoIP client 408 and determines a terminating service provider (e.g., Provider 2 404 of the second VoIP client 408) based on the unique VoIP identifier included in the request. The request is then forwarded to Provider 2 404. This call initiation will be forwarded to the device of the second VoIP client. A conversation channel between the device of the first VoIP client 406 and a device of the second VoIP client 408 can then be established.

In an illustrative embodiment, before the devices of the first VoIP client 406 and the second VoIP client 408 begin to exchange data packets, contextual information may be exchanged. As will be discussed in a greater detail below, the contextual information may be packetized in accordance with a predefined structure that is associated with the conversation. Any device associated with the first VoIP client 406, the service provider of the first VoIP client 406, or a different device/service provider may determine the structure based on the content of the contextual information. In one embodiment, the exchanged contextual information may include information relating to the calling VoIP client 406, the device, and the VoIP client 408 being called. For example, the contextual information sent from the called VoIP client 406 may include priority list of incoming calls from various potential calling VoIP clients including VoIP client 406.

Available media types, rules of the calling client and the client being called, and the like, may also be part of the contextual information that is exchanged during the connection set-up phase. The contextual information may be processed and collected by one the devices of the first VoIP client 406, one of the devices of the second VoIP client 408, and/or by VoIP service providers (e.g., Provider 1 402 and Provider 2 404), depending on the nature of the contextual information. In one embodiment, the VoIP service providers 402, 404 may add/or delete some information to/from the client's contextual information before forwarding the contextual information.

In response to a request to initiate a conversation channel, the second VoIP client 408 may accept the request for establishing a conversation channel or execute other appropriate actions such as rejecting the request via Provider 2 404. The appropriate actions may be determined based on the obtained contextual information. When a conversation channel is established, a device of the first VoIP client 406 and a device of the second VoIP client 408 start communicating with each other by exchanging data packets. As will be described in greater detail, the data packets, including conversation data packets and contextual data packets, are communicated over the established conversation channel between the connected devices.

Conversation data packets carry data related to a conversation, for example, a voice data packet, or multimedia data packet. Contextual data packets carry information relating to data other than the conversation data. Once the conversation channel is established, either the first VoIP client 406 or the second VoIP client 408 can request to terminate the conversation channel. Some contextual information may be exchanged between the first VoIP client 406 and the second VoIP client 408 after the termination.

FIG. 4B is a block diagram illustrative of a conversation flow 400 between devices of two VoIP clients via several service providers, in accordance with an embodiment of the present invention. As with FIG. 4A, the example described herein will utilize the scenario in which each client only has one device associated therewith and the connection occurs between those two devices. During a connection set-up phase, a device of a first VoIP client 406 requests to initiate a conversation channel for communication with a second VoIP client 408. In an illustrative embodiment, a VoIP service provider 402 (Provider 1) for the first VoIP client 406 receives the request to initiate a conversation channel and forwards the request to a VoIP service provider 404 (Provider 2) for the second VoIP client 408.

Before the device of the first VoIP client 406 and the device of the second VoIP client 408 begin to exchange voice data packets, contextual information may be exchanged between the first VoIP client 406 and the second VoIP client 408. Contextual information may be exchanged using a structured organization defined by the first VoIP client 406. In one embodiment, Provider 1 402 may identify particular contextual information which Provider 1 402 desires to obtain from the first VoIP client 406. The first VoIP client 406 may specify the corresponding structure based on the content of the contextual information. The identification of the structure for exchanging information and additional contextual information may be transmitted to the second VoIP client 408 via Provider 2 404 and Provider 1 402.

The contextual information may be processed and collected at a device of the first VoIP client, a device of the second VoIP client, and/or the VoIP service providers (e.g., Provider 1 and Provider 2), depending on the nature of the contextual information. For example, voice profiles may be collected by the service providers 402, 404, and only temporarily provided to the devices. Further, third party Service Provider(s) (third party SP) 410, 412 can obtain and/or add contextual information exchanged among devices of the first VoIP client 406 and second VoIP client 408, Provider 1 402, and Provider 2 404. In one embodiment, any of Provider 1 402, Provider 2 404, and third party SP 410, 412 may add, modify and/or delete contextual information before forwarding the contextual information to the next VoIP device(s), including other service providers.

In response to a request to initiate a conversation channel, the second VoIP client 408 may accept the request for establishing a conversation channel or reject the request via Provider 2 404. When a conversation channel has been established, the devices of the first VoIP client 406 and the second VoIP client 408 start communicating with each other by exchanging data packets as discussed above. In one embodiment, contextual and/or conversation data packets may be forwarded to third party SPs 410, 412 from Provider 1 402, Provider 2 404, or from either VoIP client 406, 408. Further, the forwarded contextual and/or conversation data packets may be exchanged among various third party SPs 410, 412.

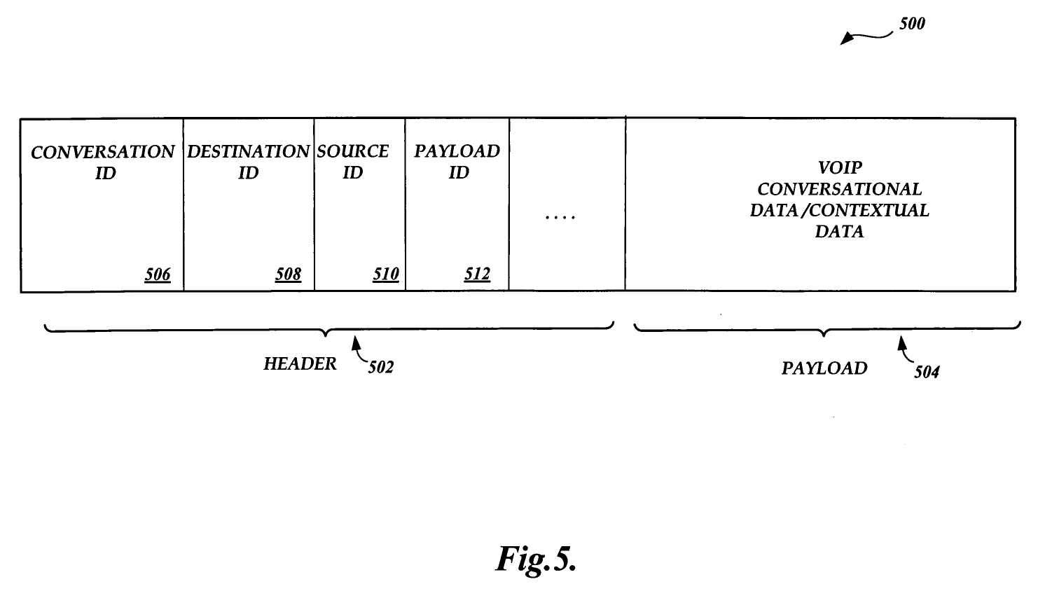

FIG. 5 is a block diagram of a data packet structure 500 used over a communication (conversation) channel in accordance with an embodiment of the present invention. The data packet structure 500 may be a data packet structure for an IP data packet suitable for being utilized to carry conversation data (e.g., voice, multimedia data, and the like) or contextual data (e.g., information relating to the VoIP services, and the like). However, any other suitable data structure can be utilized to carry conversation data or contextual data. The data packet structure 500 includes a header 502 and a payload 504. The header 502 may contain information necessary to deliver the corresponding data packet to a destination. Additionally, the header 502 may include information utilized in the process of a conversation. Such information may include conversation ID 506 for identifying a conversation (e.g., call), a Destination ID 508, such as a unique VoIP identifier of the client being called, a Source ID 510 (unique VoIP identifier of the calling client or device identifier), Payload ID 512 for identifying type of payload (e.g., conversation or contextual), individual ID (not shown) for identifying the individual for which the conversation data is related, and the like. In an alternative embodiment, the header 502 may contain information regarding Internet protocol versions, and payload length, among others. The payload 504 may include conversational or contextual data relating to an identified conversation. As will be appreciated by one of ordinary skill in the art, additional headers may be used for upper layer headers such as a TCP header, a UDP header, and the like.

In one embodiment of the present invention, a structured hierarchy may be predefined for communicating contextual information over a VoIP conversation channel. The contextual information may include any information relating to VoIP clients, VoIP devices, conversation channel connections (e.g., call basics), conversation context (e.g., call context) and the like. More specifically, the contextual information may include client preference, client rules, client's location (e.g., user location, device location, etc.), biometrics information, the client's confidential information, VoIP device's functionality, VoIP service providers information, media type, media parameters, calling number priority, keywords, information relating to application files, and the like. The contextual information may be processed and collected at each VoIP client and/or the VoIP service providers depending on the nature of the contextual data. In one aspect, the VoIP service providers may add, modify and/or delete VoIP client's contextual data before forwarding the contextual information. For example, client's confidential information will be deleted by the VoIP service provider associated with that client unless the client authorizes such information to be transmitted. In some cases, a minimal amount of contextual information is transmitted outside of an intranet network.

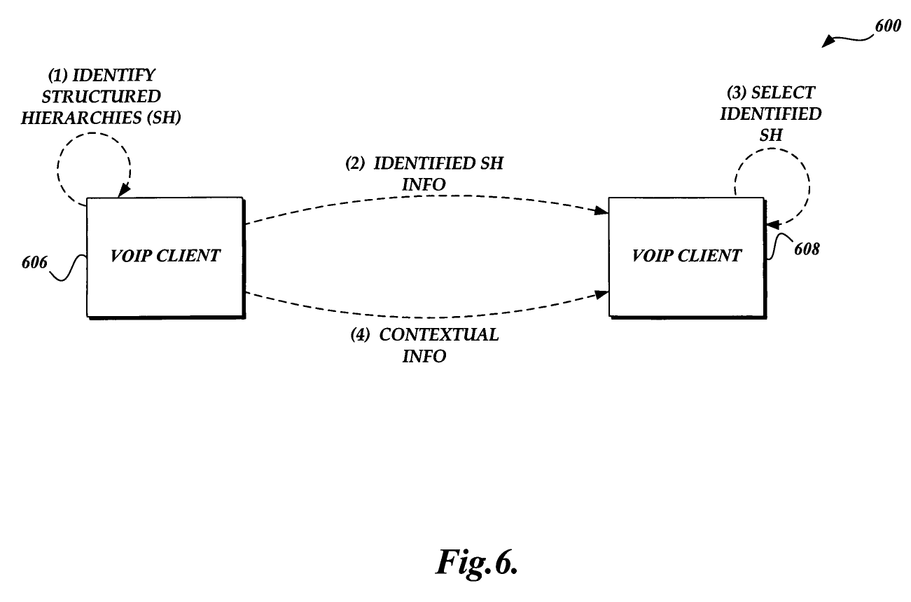

With reference to FIG. 6, a block diagram 600 illustrating interactions between two VoIP clients for transferring contextual information, in accordance with an embodiment of the present invention, is shown. As with FIGS. 4A and 4B, the example described herein will utilize the scenario in which each client only has one device associated therewith and the connection occurs between those two devices. In one embodiment, devices of VoIP Client 606 and VoIP Client 608 have established a VoIP conversation channel. It may be identified which structured hierarchies will be used to carry certain contextual information by VoIP Client 606. The information regarding the identified structured hierarchies may include information about which structured hierarchies are used to carry the contextual information, how to identify the structured hierarchy, and the like. Such information will be exchanged between VoIP Client 606 and VoIP Client 608 before the corresponding contextual information is exchanged. Upon receipt of the information about which structured hierarchy is used to carry the contextual information, VoIP Client 608 looks up predefined structured hierarchies (e.g., XML namespace and the like) to select the identified structured hierarchies. In one embodiment, the predefined structured hierarchies can be globally stored and managed in a centralized location accessible from a group of VoIP clients. In this embodiment, a Uniform Resource Identifier (URI) address of the centralized location may be transmitted from VoIP Client 606 to VoIP Client 608.

In another embodiment, each VoIP client may have a set of predefined structured hierarchies stored in a local storage of any devices or a dedicated local storage which all devices can share. The predefined structured hierarchies may be declared and agreed upon between VoIP clients before contextual information is exchanged. In this manner, the need to provide the structure of the contextual data packets may be eliminated and thus the amount of transmitted data packets corresponding to the contextual data is reduced. Further, by employing the predefined structured hierarchies, data packets can be transmitted in a manner which is independent of hardware and/or software.

Upon retrieving the identified structured hierarchy, VoIP Client 608 is expecting to receive a data stream such that data packets corresponding to the data stream are defined according to the identified structured hierarchies. VoIP Client 606 can begin sending contextual information represented in accordance with the identified structured hierarchies. In one embodiment, VoIP Client 608 starts a data binding process with respect to the contextual information. For example, instances of the identified structured hierarchies may be constructed with the received contextual information.

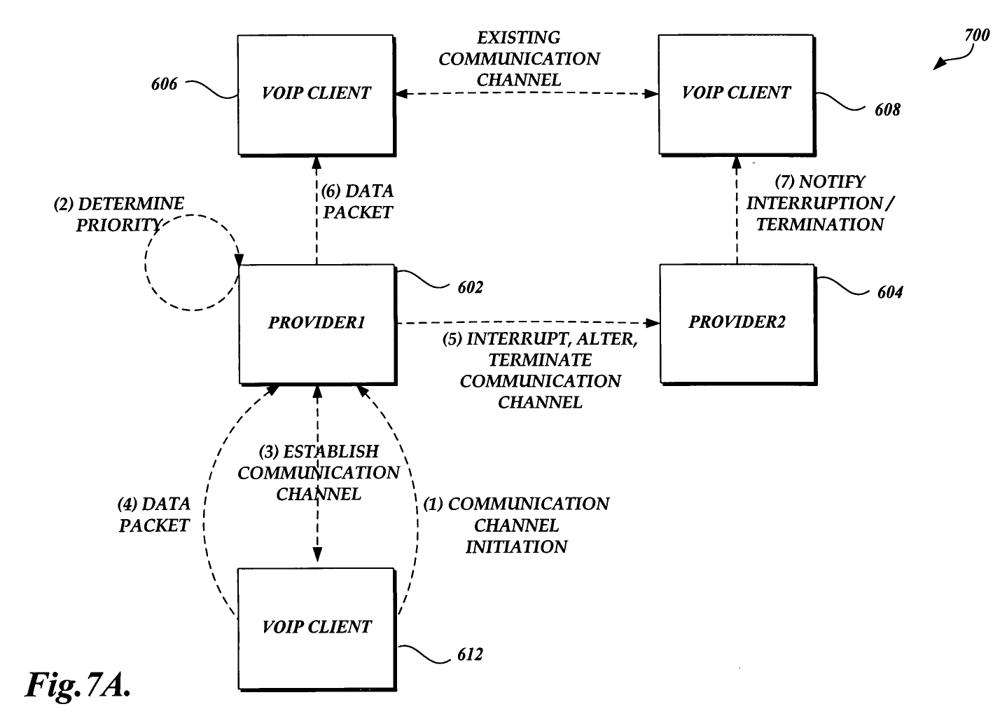

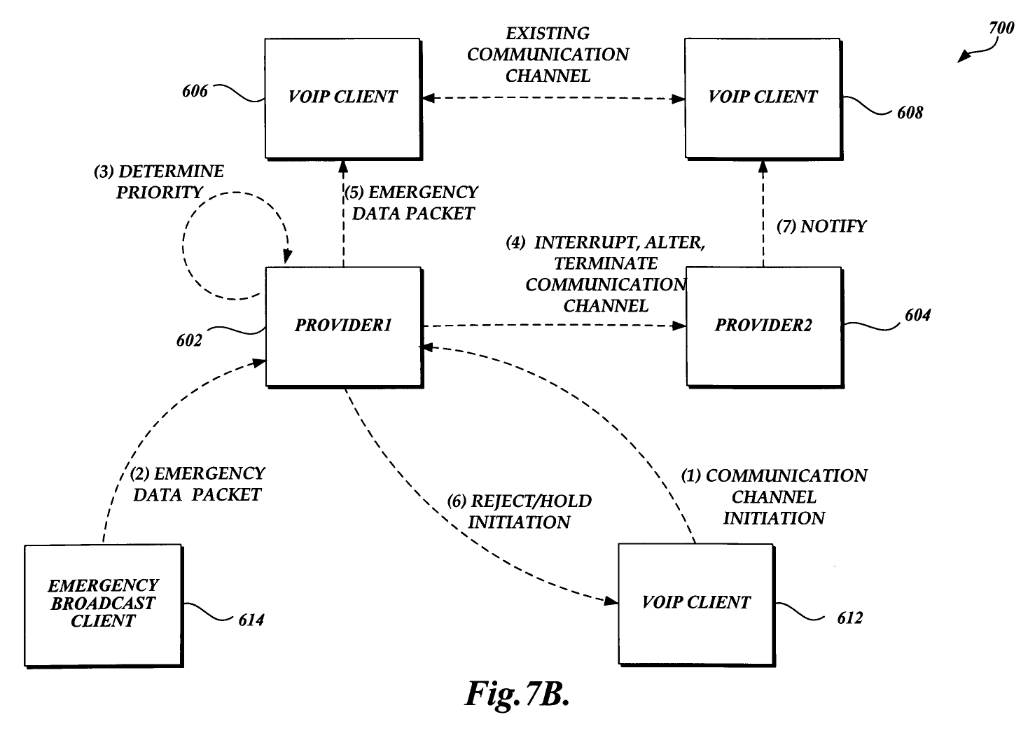

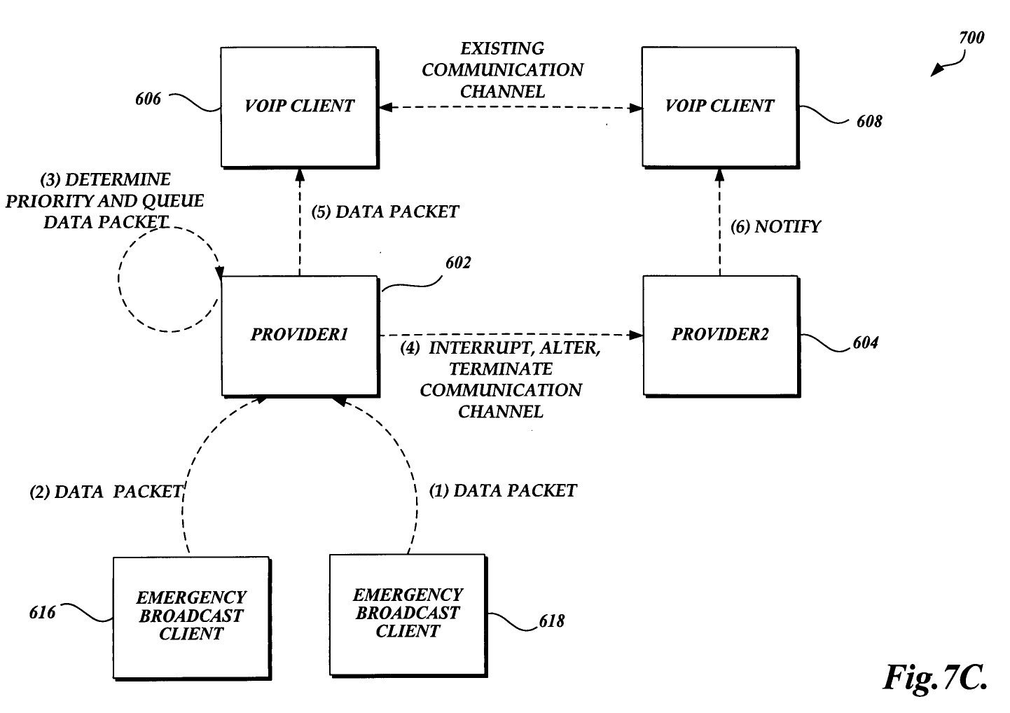

FIGS. 7A-7C are block diagrams 700 illustrating interactions among VoIP entities in the VoIP environment utilizing data packet prioritization in accordance with an aspect of the present invention. In one embodiment, the VoIP entities may include VoIP clients, VoIP service providers for the clients, third party service providers and the like. It is to be noted that one of ordinary skill in the relevant art will appreciate that any suitable entities may be included in the IP telephone environment.

With reference to FIG. 7A, in one embodiment, VoIP Client 606 may already have an existing communication channel with VoIP Client 608. While this example utilizes two VoIP service providers and two VoIP clients, any number and combination of VoIP clients and/or service providers may be used with embodiments of the present invention. A service provider of VoIP Client 606, Provider 1 602 has already obtained contextual information including priority information from VoIP Client 606. As will be described in greater detail below, it is contemplated that structured hierarchies are utilized to carry contextual information (contextual data packets) between several VoIP entities in this illustrative embodiment. In the embodiment, Provider 1 602 may receive a request from VoIP Client 612 to initiate a communication channel between devices of VoIP Client 612 and VoIP Client 606. Provider 1 602 may determine priority levels of VoIP Client 608 and VoIP Client 612 based on the priority information obtained from VoIP Client 606. In one embodiment, contextual information corresponding to the priority information may include a predefined priority level for each potential VoIP client that may call VoIP Client 606. Alternatively, a predefined priority level can be specified based on a membership associated with a particular group of potential callers, or the VoIP client associated with the caller. In this example, if a potential caller is identified as a member of a particular group (e.g., a family, a customer, an emergency, a project team, etc), a priority level of the particular group will be assigned to the potential caller.

If Provider 1 602 determines that VoIP Client 612 has higher priority than VoIP Client 608, Provider 1 602 accepts the request to initiate a communication channel between VoIP Client 612 and VoIP Client 606. The communication channel is established between VoIP Client 612 and VoIP Client 606. VoIP Client 612 starts sending data packets to Provider 1 602 over the established communication channel. In one embodiment, Provider 1 602 may terminate, interrupt, or alter the existing communication channel between VoIP Client 606 and VoIP Client 608. Upon termination of the existing communication channel, Provider 2 604 may notify VoIP Client 608 of the termination. In an alterative embodiment, Provider 1 602 may interrupt the existing communication channel by putting on hold data packets transmitted from VoIP Client 608. Upon interruption of the existing communication channel, Provider 2 604 may notify VoIP Client 608 of the interruption. As will be appreciated by one of ordinary skill in the art, VoIP Client 608 can terminate the communication channel any time during the interruption. After the communication channel between VoIP Client 606 and VoIP Client 608 has been terminated or interrupted, VoIP Client 606 and VoIP Client 612 can exchange data packets between each other over the newly established communication channel. Provider 1 602 may transmit the data packets received from VoIP Client 612 to the VoIP Client 606. It is contemplated that an authorized VoIP client or device can force a change in priority levels of data packets even after the priority levels have been determined. Such a change may occur at any time (e.g., before, during, and/or after a conversation). It is also contemplated that the priority levels of data packets can be dynamically evaluated and altered based on contextual information received from VoIP clients, service providers, or other VoIP entities.

In one embodiment, priority levels of data packets may be determined based on numerous kinds of information including priority of sending client, size and type (e.g., multimedia, text, audio, application file, and the like) of data packets, callee preferences and the like. In an illustrative embodiment, Provider 1 602 may determine the priority level of data packets based on the type of data packets when it is not able to compare the priority levels of VoIP Client 612 and VoIP Client 608. For example, VoIP Client 612 and VoIP Client 608 have the same level of priority. Provider 1 602 may assign priorities such that data packets requiring real-time data transfer have a higher priority than others. Similarly, Provider 1 602 may consider the size of the contextual information. Data packets relating to contextual information which have a small amount of information may have higher priority than others.

With reference to FIG. 7B, in another illustrative embodiment, a device of VoIP Client 606 may already have an existing communication channel with VoIP Client 608. Provider 1 602 may receive a request from VoIP Client 612 to initiate a new communication channel with VoIP Client 606. At approximately the same time, Provider 1 602 may receive an emergency data packet from Emergency Broadcast (EB) Client 614 (e.g., emergency broadcasting message to VoIP clients in certain geographic areas). It is contemplated that EB Client 614 may include any client with an authority to broadcast emergency data packets via its associated one or more providers. In this embodiment, Provider 1 602 may provide VoIP services to both VoIP Client 612 and EB Client 614. In order to decide which data packet is to be transmitted to VoIP Client 606, Provider 1 602 determines priority levels of VoIP Client 608, VoIP Client 612 and EB Client 614 based on the priority information obtained from VoIP Client 606. In one embodiment, the priority information may include a predefined priority level for each potential caller for the VoIP Client 606, a predefined priority level for a group of potential callers, or the like.

In an illustrative embodiment, VoIP Client 606 may have specified a higher priority level to EB Client 614 than VoIP Client 612 or VoIP Client 608. In this embodiment, Provider 1 602 may terminate, interrupt, or alter the existing communication channel in order to transmit EB data packets. Upon termination of the existing communication channel, Provider 2 604 may notify VoIP Client 608 of the termination. However, based on the client preference information of VoIP Client 606, Provider 1 602 may interrupt the existing communication channel by putting on hold data packets from VoIP Client 608. Upon interruption of the existing communication channel, Provider 2 604 may notify VoIP Client 608 of the interruption. VoIP Client 608 can terminate the existing communication channel any time during the interruption. Provider 1 602 rejects the request from VoIP Client 612 to initiate a communication channel.

After terminating, interrupting, or altering the communication channel between VoIP Client 606 and VoIP Client 608, Provider 1 602 may transmit the emergency data packets received from EB Client 614 to the VoIP Client 608. Generally, a typical two-way communication channel may not be necessary for emergency broadcasting and thus VoIP Client 606 can receive incoming data packets from EB Client 614 but not be able to send outgoing data packets to EB Client 614.

With reference to FIG. 7C, in one embodiment, a device of VoIP Client 606 may already have an existing communication channel with VoIP Client 608. Provider 1 602 may receive emergency data packets from one or more EB clients 616, 618. In this embodiment, Provider 1 602 may receive a first set of emergency data packets from EB Client 616 and a second set of emergency data packets from EB Client 618. Provider 1 602 may determine priority levels of EB Client 616 and EB Client 618 based on the priority information obtained from VoIP Client 606, or based on a predefined priority information for EB clients. In one embodiment, contextual information corresponding to the priority information may be exchanged to provide information relating to a predefined priority level for each potential caller for VoIP Client 606, a predefined priority level for a group of potential callers, or the like.

In one embodiment, VoIP Client 606 may have specified a predefined priority level for a group of potential callers. For example, VoIP Client 606 may have assigned the highest priority level to a group of EBs, the second highest priority level to family members, the third highest level to friends and so on. Although EBs have the highest priority, individual EBs (e.g., EB Client 616 and EB Client 618) cannot be compared since they may have the same level of priority. In this embodiment, provider may maintain a provider priority list for emergency clients and determine the priority level for EB Client 616 and EB Client 618 based on the provider priority list in conjunction with the priority information provided from VoIP Client 606.

For the purpose of discussion, assume that Provider 1 602 may determine that EB Client 616 has a higher priority than EB Client 618. As explained above, Provider 1 602 may terminate, interrupt, or alter the existing communication channel between VoIP Client 606 and VoIP Client 608. Upon termination of the existing communication channel, Provider 2 604 may notify VoIP Client 608 of the termination. Likewise, upon interruption of the existing communication channel, Provider 2 604 may notify VoIP Client 608 of the interruption. VoIP Client 608 can terminate the communication channel any time during the interruption. After terminating or interrupting the existing communication channel between VoIP Client 606 and VoIP Client 608, Provider 1 602 may transmit the emergency data packets transmitted from EB Client 616 to VoIP Client 606. As will be appreciated by one of ordinary skill in the art, a typical two-way communication channel may not be necessary for emergency broadcasting and thus VoIP Client 606 may receive incoming data packets from EB Client 614 but not be able to send outgoing data packets. In an alternative embodiment, Provider 1 602 may store data packets transmitted from EB Client 618 in a storage area such as a buffer and the like. The stored emergency data packets may be transmitted after data packets from EB Client 616 have been transmitted.

As mentioned above, structured hierarchies may be identified for communicating contextual information corresponding to called VoIP client's priority information. Further, the information regarding the identified structured hierarchies may be transmitted. The information regarding the identified structured hierarchies may include the information about which structured hierarchies carry the contextual information, how to identify the structured hierarchies, and the like. Subsequently, the contextual information corresponding to priority information may be represented in accordance with the identified structured hierarchies and transmitted.

In one embodiment, the structured hierarchies may be defined by Extensible Markup Language (XML). However, it is to be appreciated that the structured hierarchies can be defined by any language suitable for implementing and maintaining extensible structured hierarchies. Generally described, XML is well known for a cross-platform, software and hardware independent tool for transmitting information. Further, XML maintains its data as a hierarchically-structured tree of nodes, each node comprising a tag that may contain descriptive attributes. Typically, an XML namespace is provided to give the namespace a unique name. In some instances, the namespace may be used as a pointer to a centralized location containing default information about the namespace.

In an illustrative embodiment, VoIP Client 606 may identify an XML namespace for contextual information. For example, the XML namespace attribute may be placed in the start tag of a sending element. It is to be understood that XML namespaces, attributes, classes illustrated herein are provided merely as an example of structured hierarchies used in conjunction with various embodiments of the present invention. After VoIP Client 608 receives the XML namespace information, the VoIP Client 606 transmits a set of contextual data packets defined in accordance with the identified XML namespace to VoIP Client 608. When a namespace is defined in the start tag of an element, all child elements with the same prefix are associated with the same namespace. As such, VoIP Client 608 and VoIP Client 606 can transmit contextual information without including prefixes in all the child elements, thereby reducing the amount of data packets transmitted for the contextual information.

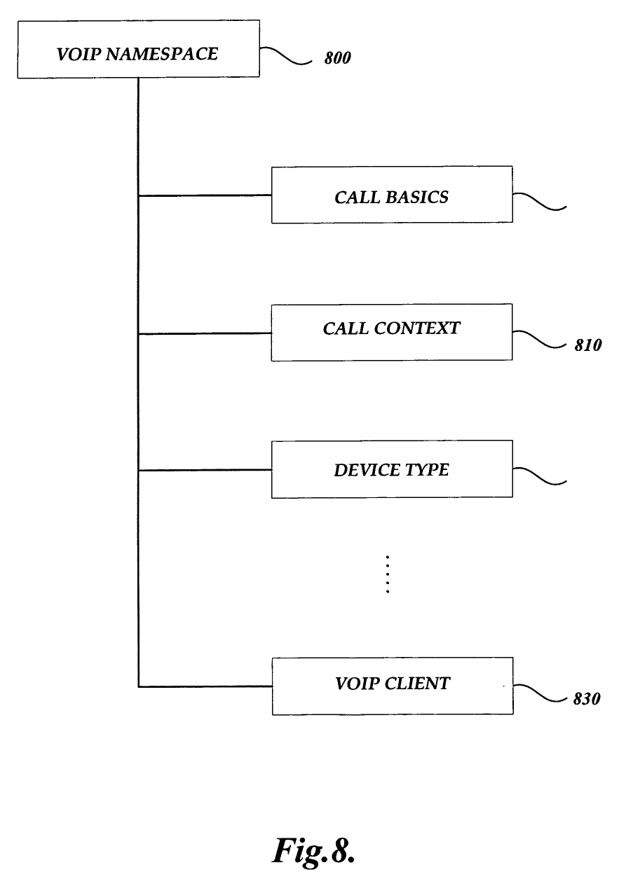

With reference to FIGS. 8-12, block diagrams illustrative of various classes and attributes of structured hierarchies corresponding to VoIP contextual information are shown. The VoIP contextual information exchanged between various VoIP entities (e.g., clients, service providers, etc.) may correspond to a VoIP namespace 800. In one embodiment, the VoIP namespace 800 is represented as a hierarchically structured tree of nodes, each node corresponding to a subclass which corresponds to a subset of VoIP contextual information. For example, a VoIP Namespace 800 may be defined as a hierarchically structured tree comprising a Call Basics Class 802, a Call Contexts Class 810, a Device Type Class 820, a VoIP Client Class 830 and the like.

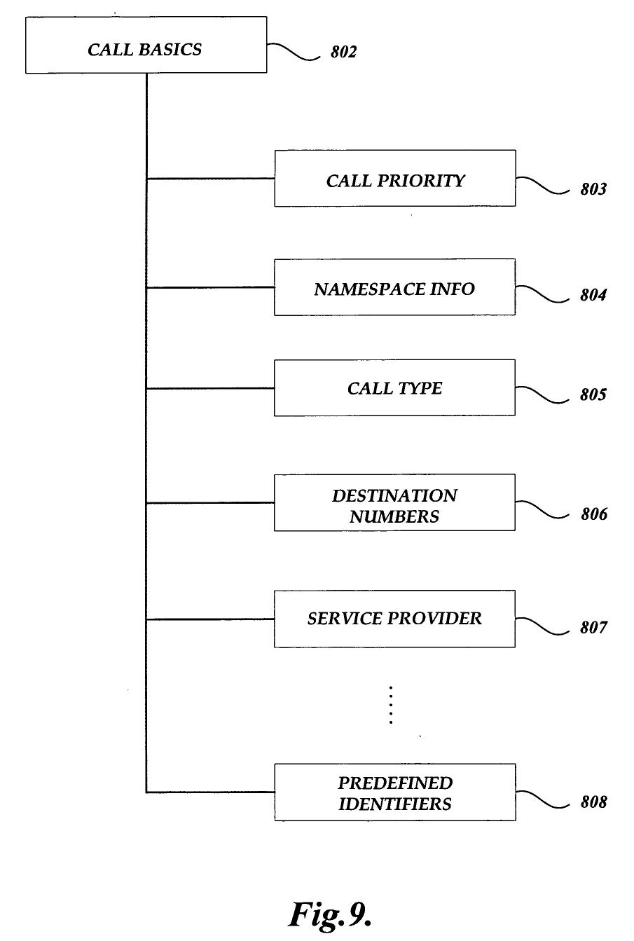

With reference to FIG. 9, a block diagram of a Call Basics Class 802 is shown. In an illustrative embodiment, Call Basics Class 802 may correspond to a subset of VoIP contextual information relating to a conversation channel connection (e.g., a PSTN call connection, a VoIP call connection, and the like). The subset of the VoIP contextual information relating to a conversation channel connection may include originating numbers (e.g., a caller's VoIP ID number), destination numbers (e.g., callees' VoIP ID numbers or telephone numbers), call connection time, VoIP service provider related information, and/or ISP related information such as IP address, MAC address, namespace information and the like. Additionally, the contextual information relating to a conversation channel connection may include call priority information (which defines the priority levels of the destination numbers), call type information, and the like. The call type information may indicate whether the conversation channel is established for an emergency communication, a broadcasting communication, a computer to computer communication, a computer to POTS device communication, and so forth. In one embodiment, the contextual information relating to a conversation channel connection may include predefined identifiers which represent emotions, sounds (e.g., “ah,” “oops,” “wow,” etc.) and facial expressions in graphical symbols. In one embodiment, a Call Basics Class 802 may be defined as a sub-tree structure of a VoIP Namespace 800, which includes nodes such as call priority 803, namespace information 804, call type 805, destination numbers 806, service provider 807, predefined identifiers 808, and the like.

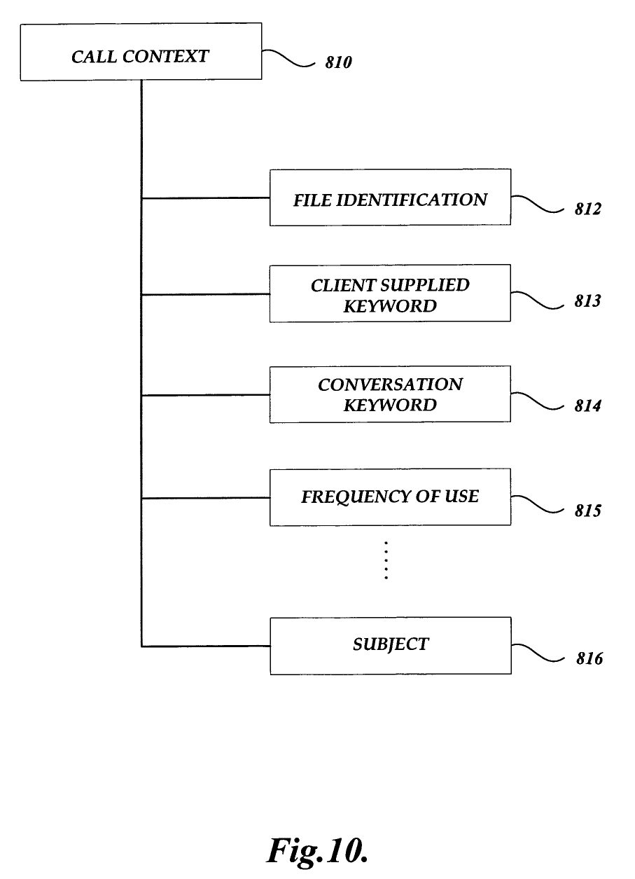

With reference to FIG. 10, a block diagram of a Call Contexts Class 810 is shown. In one embodiment, a subset of VoIP contextual information relating to conversation context may correspond to the Call Contexts Class 810. The contextual information relating to conversation context may include information such as client supplied keywords, identified keywords from document file data, identified keywords from a conversation data packet (e.g., conversation keywords), file names for documents and/or multimedia files exchanged as part of the conversation, game related information (such as a game type, virtual proximity in a certain game), frequency of use (including frequency and duration of calls relating to a certain file, a certain subject, and a certain client), and file identification (such as a case number, a matter number, and the like relating to a conversation), among many others. In accordance with an illustrative embodiment, a Call Contexts Class 810 may be defined as a sub-tree structure of a VoIP Namespace 800, which includes nodes corresponding to file identification 812, client supplied keyword 813, conversation keyword 814, frequency of use 815, subject of the conversation 816, and the like.

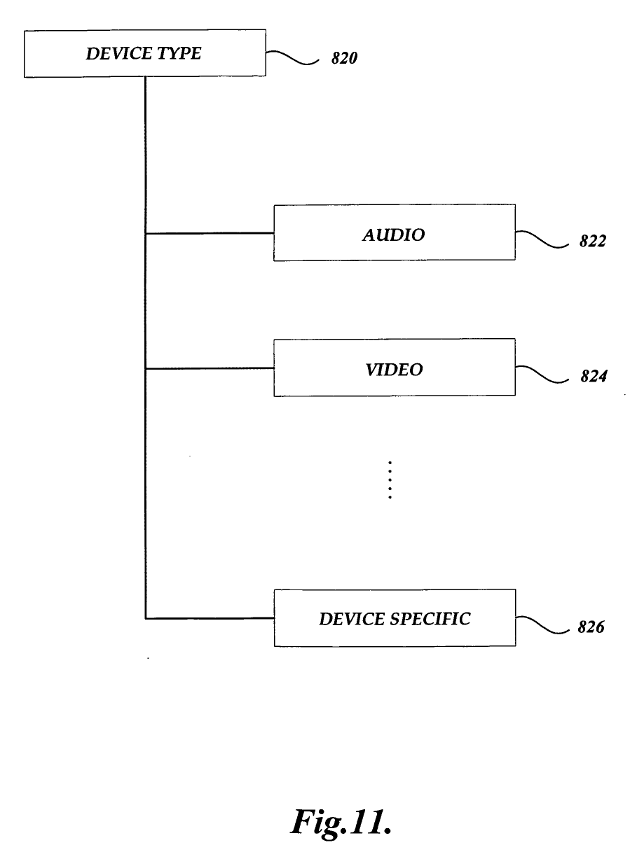

With reference to FIG. 11, a block diagram of a Device Type Class 820 is depicted. In one embodiment, a Device Type Class 820 may correspond to a subset of VoIP contextual information relating to a VoIP client device used for the conversation channel connection. The subset of the VoIP contextual information relating to the VoIP client device may include audio related information which may be needed to process audio data generated by the VoIP client device. The audio related information may include information related to the device's audio functionality and capability, such as sampling rate, machine type, output/input type, microphone, Digital Signal Processing (DSP) card information, and the like. The subset of the VoIP contextual information relating to the VoIP client device may include video related information which may be needed to process video data generated by the VoIP client device. The video related information may include resolution, refresh, type and size of the video data, graphic card information, and the like. The contextual information relating to VoIP client devices may further include other device specific information such as a type of the computer system, processor information, network bandwidth, wireless/wired connection, portability of the computer system, processing settings of the computer system, and the like. In an illustrative embodiment, a Device Type Class 820 may be defined as a sub-tree structure of a VoIP Namespace 800, which includes nodes corresponding to Audio 822, Video 824, Device Specific 826 and the like.

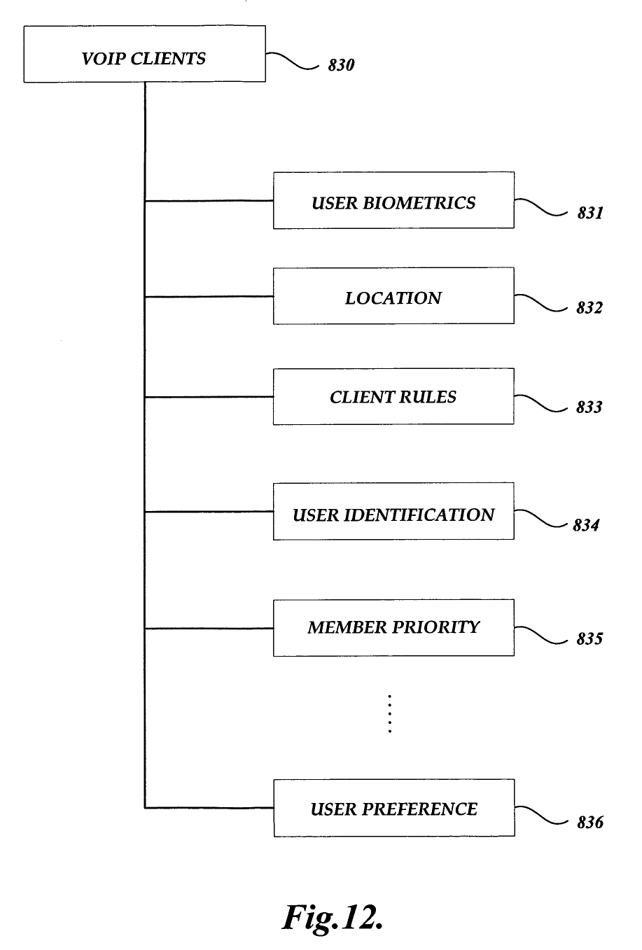

With reference to FIG. 12, a block diagram of a VoIP Client Class 830 is depicted. In accordance with an illustrative embodiment, a VoIP Client Class 830 may correspond to a subset of contextual information relating to VoIP clients. In one embodiment, the subset of the VoIP contextual information relating to the VoIP client may include voice profile information (e.g., a collection of information specifying the tonal and phonetic characteristics of an individual user), digital signature information, and biometric information. The biometric information can include user identification information (e.g., fingerprint) related to biometric authentication, user stress level, user mood, etc. Additionally, the subset of the VoIP contextual information relating to the VoIP client may include location information (including a client defined location, a VoIP defined location, a GPS/triangulation location, and a logical/virtual location of an individual user), assigned phone number, user contact information (such as name, address, company, and the like), rules defined by the client, user preferences, digital rights management (DRM), a member rank of an individual user in an organization, priority associated with the member rank, and the like. The priority associated with the member rank may be used to assign priority to the client for a conference call. In one embodiment, a VoIP Client Class 830 may be defined as a sub-tree structure of a VoIP Namespace 800, which includes nodes corresponding to user biometrics 831, location 832, client rules 833, user identification 834, member priority 835, user preference 836, and the like.

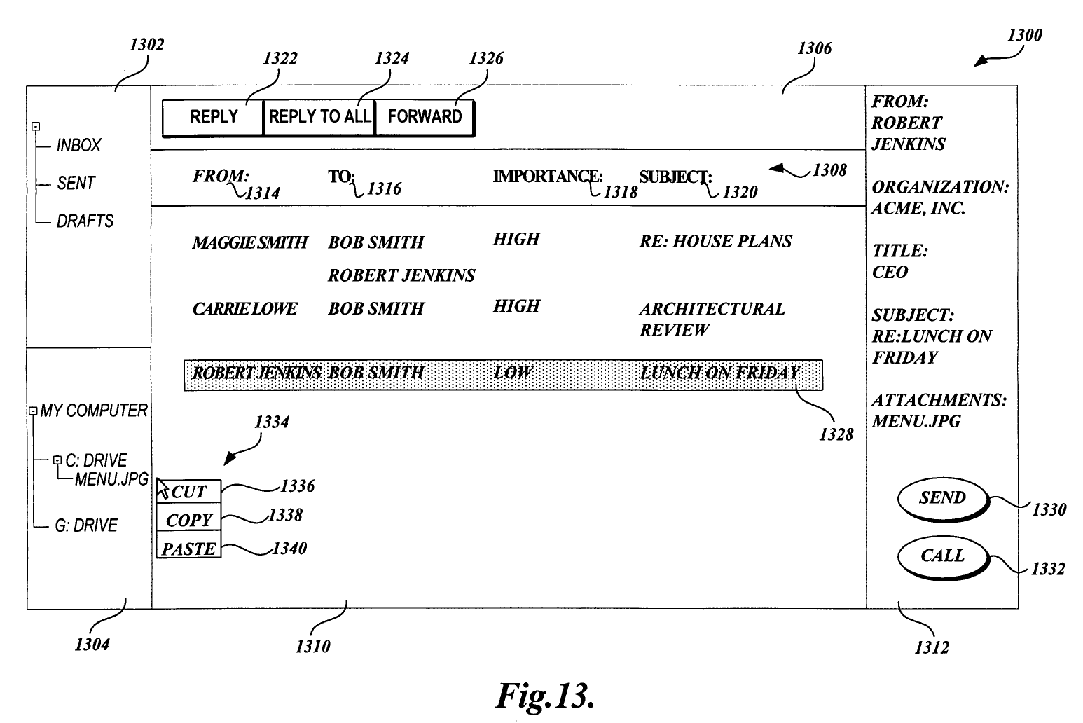

Now with reference to FIGS. 13-16, an aspect of the present invention that provides controls for creating a new or draft voicemail message that is related to a received voicemail message will be described. Those skilled in the art and others will recognize that an IP telephony environment 100 may include a voicemail system that allows a caller to leave an audio and/or multimodal message (e.g., audio with an electronic file) for a callee. For example, a VoIP service provider 132 may provide VoIP clients 134 with voicemail services that allow a caller to leave a voicemail message in a voice mailbox. In some systems, the callee may listen to the voicemail message from a client device using a voicemail or e-mail application program to access the voice mailbox. In other instances and by way of example only, the callee may access a voice mailbox and listen to a voicemail message from an audio menu provided by a service provider.

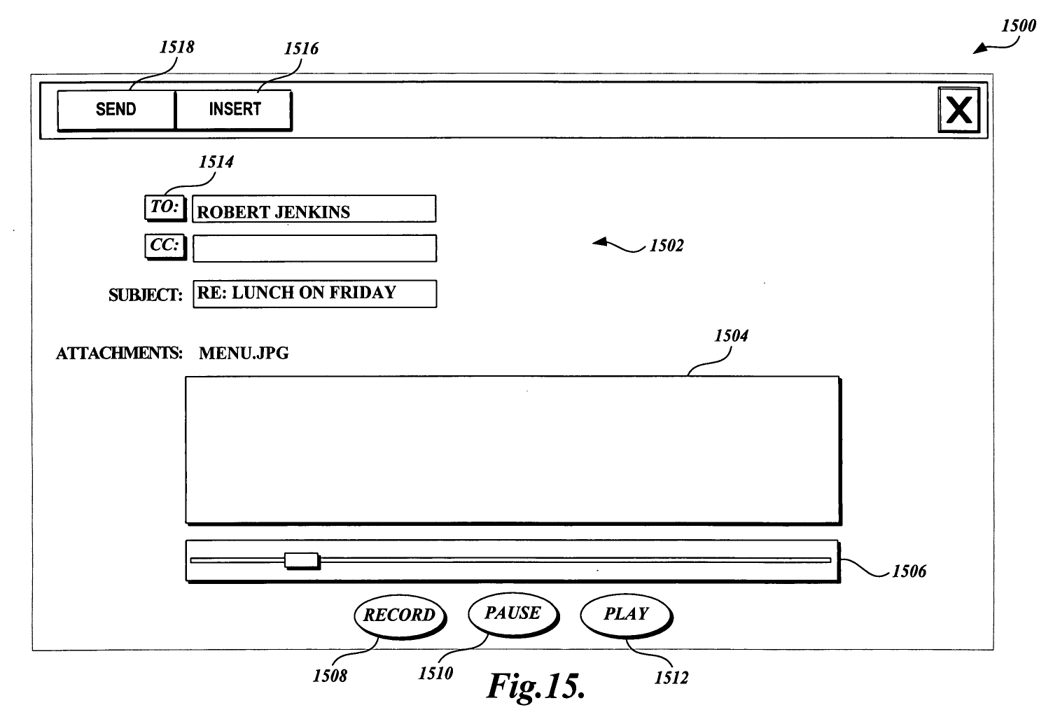

In accordance with one embodiment of the present invention, a selection user interface with controls (e.g., buttons, menu items, etc.) is provided for creating a draft voicemail message that is related to a received voicemail message. As described in further detail below, the selection user interface serves as a central location where all voicemail messages received by a primary callee may be accessed. From the selection user interface, controls may be activated to create a draft voicemail message that is a “reply,” “forward,” or “reply to all” to a received voicemail message. Once the draft voicemail message is created, the primary callee may interact with an update user interface (FIG. 15) to input conversational and/or contextual data to finalize the creation of the voicemail message. In this regard, if the callee has the sufficient permission levels and rights to data that is being forwarded, controls available from the update user interface allow the primary callee to send the voicemail message to a secondary callee.

While the description provided below includes examples of specific user interfaces and controls, those skilled in the art and others will recognize that aspects of the present invention may be applied in other contexts without departing from the scope of the claimed subject matter. Moreover, while the examples provided below are principally described in the context of allowing a callee to create and send a voicemail message from a GUI, the same or similar techniques may be used by other software systems to automatically create and send a voicemail message. For example, instead of the controls described below being accessed from a GUI, the controls may be accessed by from an Application Programming Interface (“API”), software library, and the like. In this regard, other software systems such as other programs, agents, services, BOTS, and the like may access the functionality provided by the present invention by issuing the appropriate function calls.

For illustrative purposes and by way of example only, an exemplary selection user interface 1300 that includes controls provided by aspects of the present invention is depicted in FIG. 13. In this embodiment, the selection user interface 1300 includes a plurality of display regions including a folder tree region 1302, drive region 1304, header region 1306, a field region 1308, identification region 1310, and launch region 1312. Each of the display regions 1302, 1304, 1306, 1308, 1310, and 1312 present different types of data and/or controls that may be used to process a received voicemail message.

The field region 1308 identifies different categories of contextual data that may be displayed with each voicemail message presented in the identification region 1310. In the exemplary selection user interface 1300 depicted in FIG. 13, the field region 1308 includes a “FROM” field 1314, “TO” field 1316, “IMPORTANCE” field 1318, and “SUBJECT” field 1320. Each voicemail message accessible from the identification region 1310 presents the contextual data categorized in the field region 1308, if available. However, the fields 1314, 1316, 1318, and 1320 depicted in FIG. 13 should be construed as exemplary, as other types of contextual data may be presented. For example, a primary callee may define preferences to display different types of contextual data without departing from the scope of the claimed subject matter. Moreover, fewer or additional fields may be presented than those depicted on the selection user interface 1300 in FIG. 13.

The folder tree region 1302 allows a primary callee to navigate and organize voicemail messages by providing different navigable folders. More specifically, and in accordance with one embodiment, when a folder is selected from the folder tree region 1302, voicemail messages stored in the selected folder are presented in the identification region 1310.

In the exemplary selection user interface 1300 depicted in FIG. 13, the identification region 1310 includes entries that represent three (3) received voicemail messages. In one embodiment, a primary callee may generate a voicemail selection event from the selection user interface 1300. For example, a mouse or other input device may be used to “click” on a voicemail entry represented on the identification region 1310. Then, a control available from the header region 1306, such as the “REPLY” button 1322, “REPLY TO ALL” button 1324, or “FORWARD” button 1326, may be activated using the same or similar technique. In response, aspects of the present invention create the appropriate draft voicemail message. Then an update user interface 1500 (FIG. 15) is presented that allows, among other things, the body of the voicemail message to be input into the client device. However, a description of the ways in which the body of a voicemail message may be input is described in further below with reference to FIG. 15. Moreover, as mentioned previously, controls provided by the present invention such as the controls represented by the “REPLY” button 1322, “REPLY TO ALL” button 1324, or “FORWARD” button 1326, may also be accessed from an API, software library, and the like. As a result, other software systems may access the functionality provided by these controls to automatically create a draft voicemail message.

Controls accessible from the selection user interface 1300 allow a primary callee to send an electronic file and/or initiate a call based on information provided in a received voicemail message. In the example illustrated in FIG. 13, a primary callee selected a voicemail message represented by the entry 1328. As a result, the launch region 1312 presents detailed information, accessible from a database commonly known as an address book, which describes the contact that authored the selected voicemail message. In this exemplary embodiment, the selection user interface 1300 includes a drive region 1304, where a primary callee may browse a file system and select a file that will be transmitted to the specified contact. For example, using a technique known as “drag-and-drop,” a primary callee may select a file by navigating folders accessible from the drive region 1304 and “drop” the selected file on the launch region 1312. In this instance, the selected file is included in the transmission to the specified contact if either the “SEND” button 1330 or the “CALL” button 1332 is activated.

The selection user interface 1300 provides other exemplary controls for selecting a file that will be included in a transmission to a secondary callee. In this regard, a primary callee may access the pop-up menu 1334 that includes a “CUT” menu item 1336, a “COPY” menu item 1338, and a “PASTE” menu item 1390, by “right-clicking” on an entry presented on the selection user interface 1300. For example, by activating the “COPY” menu item 1338 when a file presented in the drive region 1304 is selected, the primary callee generates a command to add the selected file to a data store known as a clipboard. Then, by activating the “PASTE” menu item 1340 while inside the launch region 1312, the primary callee generates a command to add the file as an attachment to a transmission initiated from the launch region 1312.

In this exemplary embodiment, the launch region 1312 includes a “SEND” button 1330 and a “CALL” button 1332. When activated, the “CALL” button 1332 initiates a call to the contact identified in the launch region 1312. Moreover, any contextual data identified by a primary callee as an attachment is transmitted to the contact when the call is initiated. Similarly, when the “SEND” button 1330 is activated, any contextual data added to the launch region 1312 is transmitted to the specified contact. However, in this instance, a call connection is not initiated and data is transmitted in response to a received voicemail message. In one embodiment, a file may be delivered to a specified contact using typical electronic file transfer techniques. Alternatively, if the primary callee is currently communicating with the specified contact, the file may be transmitted over an established communication channel.

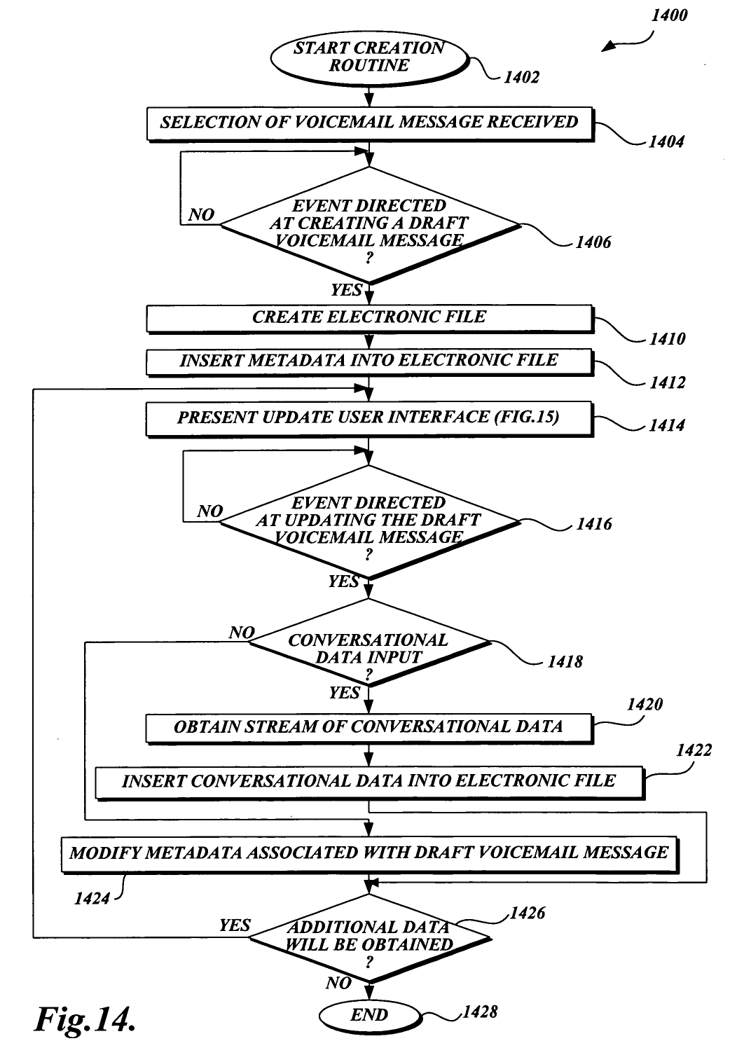

Now with reference to FIG. 14, a creation routine 1400 that provides logic for creating and modifying a draft voicemail that is related to a received voicemail message will be described. As illustrated in FIG. 14, the creation routine 1400 begins at block 1402 and at block 1404 the selection of a voicemail message is received. As mentioned previously, a primary callee may access his or her voicemail messages in a number of different ways. For example, an application program such as a voicemail application program, an e-mail application program, etc., may be used to access voicemail messages stored in a voice mailbox. In this instance and by way of example only, a primary callee may select a voicemail message using controls accessible from a user interface, such as the selection user interface 1300 described above with reference to FIG. 13. In other instances, a voicemail message may be selected, at block 1404, using a different type of interface. For example, the primary callee may access voicemail messages from an audio menu provided by a service provider. From the audio menu, the primary callee may use a client device that is only capable of capturing audio data, such as a POTS telephone, to select a voicemail message by responding to audio prompts. While specific examples have been described, it should be well understood that a primary callee may select a voicemail message, at block 1404, using other techniques than those described herein.

At decision block 1406, the creation routine 1400 remains idle until an event that is directed at creating a draft voicemail message is received. As mentioned previously, controls accessible from the selection user interface 1300 may be activated to create a draft voicemail message that is related to a received voicemail message. Those skilled in the art and others will recognize that an operating system on a client device manages input/output (“I/O”) on behalf of application programs. In this regard, events generated from the selection user interface 1300 are satisfied in modules of program code commonly known as event handlers. Thus, when a control presented on the selection user interface 1300 is activated, an operating system receives notice of the event and calls the appropriate event handler. By way of example only, if the event handler called at block 1406 is associated with the “REPLY” button 1322, “REPLY TO ALL” button 1324, or “FORWARD” button 1326, then a determination is made at block 1406 that an event directed at creating a draft voicemail message was received and the creation routine 1400 proceeds to block 1410.

At block 1410, an electronic file (“draft voicemail message”) is created that may be subsequently populated with conversational and/or contextual data. Creating the electronic file, at block 1410, may be performed using techniques that are generally known in the art. For example, by issuing an appropriate application program interface (“API”) call to the operating system that manages I/O on a client device, the electronic file may be created.

As illustrated in FIG. 14, at block 1412, the creation routine 1400 inserts metadata in the electronic file (e.g., draft message) that reflects the type of voicemail message that is being created. In accordance with one embodiment, when block 1412 is reached, a primary callee activated a control such as the “REPLY” button 1322, “REPLY TO ALL” button 1324, or “FORWARD” button 1326 from the selection user interface 1300 (FIG. 13). In this instance, metadata that is appropriate for the type of voicemail message being created is added to the draft voicemail message. As mentioned previously, contextual data that defines a subject line, secondary callees, file attachments, and the like are defined in metadata of a voicemail message. At block 1412, the creation routine 1400 determines which type of voicemail message is being created and inserts metadata into the electronic file, created at block 1410, that depends on the control that was activated by the primary callee. For example, if the control activated is the “REPLY” button 1322, the caller who authored the original voicemail message is identified as a secondary callee in the metadata of the draft voicemail message being created. Moreover, a “subject line” provided in the original voicemail message will typically be inserted into the subject line of the draft voicemail message along with an identifier (e.g., “RE”). Similarly, if the control activated was the “REPLY TO ALL” button 1324, the caller who authored the original voicemail message is identified as a secondary callee in the metadata inserted into the draft voicemail message at block 1412. Moreover, any contacts provided with a “carbon copy” of the original voicemail message are included, by default, as receiving a “carbon copy” of the draft voicemail message. However, the entries provided by default may be modified by the callee who may identify a different set of contacts that will be provided with the “carbon copy.” Also, if the control activated was the “FORWARD” button 1326, a “subject line” provided in the original voicemail message may be inserted into the metadata that defines the “subject line” of the draft voicemail message along with an identifier (e.g. “FW”).

In response to an event directed at generating a draft voicemail message being received, an update user interface 1500 (FIG. 15) is presented at block 1414. Among other things, the update user interface 1500 provides controls for obtaining conversational and/or contextual data from the primary callee that will be included in the draft voicemail message.

For illustrative purposes and by way of example only, an exemplary update user interface 1500 is depicted in FIG. 15. The update user interface 1500 provides readily understandable controls for accepting input to modify a draft voicemail message. In this regard, the update user interface 1500 depicted in FIG. 15 includes a header region 1502, a text input box 1504, a progress bar 1506, and a plurality of selectable buttons associated with the progress bar 1506, including a “RECORD” button 1508, a “PAUSE” button 1510, and a “PLAY” button 1512.

In the header region 1502, different categories of contextual data associated with the draft voicemail message are presented. The contextual data presented, by default, is defined in the metadata inserted into the draft voicemail message at block 1412. However, the primary callee may modify the contextual data associated with the draft voicemail message by using controls available from the update user interface 1500. In this regard, the header region 1502 includes a “TO” button 1514 and an associated editable textbox. The textbox identifies the secondary callee(s) who are currently designated to receive the draft voicemail message. In one embodiment, a draft voicemail message's secondary callee(s) may be identified through the use of the “TO” button 1514 that, when activated, provides access to a database of contacts (e.g., “address book”). From the address book, a contact may be added as a callee to the draft voicemail message. Similarly, a contact who will be provided with a “carbon copy” of the draft voicemail message may be identified using similar techniques. Also, other contextual data associated with the draft voicemail message may be input using the update user interface 1500. For example, text may be input into the subject line or text input box 1504 of the voicemail message using a standard input device (e.g., keyboard).

Alternatively, speech recognition software may be utilized to convert audio into text that will be included as contextual data in the draft voicemail message. For example, the body of the original voicemail message may be processed using speech recognition technology to automatically identify a “subject” line for the draft voicemail message being created. Similarly, all or a portion of the audio that is included in the body of the voicemail message being created may be converted from audio to text and inserted into a subject line or the text input box 1504. As a result, a secondary callee who receives the voicemail message may be able to use a client device that is limited to providing information in a text-based format.

By interacting with the update user interface 1500, file attachments may be added/removed from the draft voicemail message as needed. In this regard, the update user interface 1500 provides a control in the form of an “INSERT” button 1516 that provides a way for a primary callee to browse a file system accessible from the client device and select an electronic file that will be included as an attachment to the draft voicemail message. Moreover, once the creation of the voicemail message is complete, the primary callee may cause the voicemail message to be transmitted to a secondary callee by activating the “SEND” button 1518.

From the update user interface 1500, controls are provided for obtaining the body of the voicemail message. For example, in one embodiment, by activating the “RECORD” button 1508, a command is generated to use the audio system of a client device to capture audio data that will be included in body of the draft voicemail message. As the body of a draft voicemail message is received, a caller may activate the “PAUSE”button 1510 to temporarily suspend recording. Moreover, once the body of the voicemail message has been recorded, the “PLAY” button 1512 may be activated/deactivated for generating a command to listen to the captured audio data. In this regard, the progress bar 1506 depicted in FIG. 15 provides dynamic visual updates regarding the extent to which a data stream included in the body of a voicemail message has been recorded/played. Any type of audio system accessible from client devices and/or a media player program may be used to record, pause, and/or play the body of the voicemail message.

Those skilled in the art and others will recognize that the description provided above with reference to FIG. 15 is a highly simplified example of one exemplary update user interface 1500. However, the features of the present invention may be implemented using a different type of interface. For example, the update user interface 1500 does not have to be a GUI, but may be rendered as a text display without graphical components, provided via audio prompts, exposed in an API or library routine, and the like. Moreover, commands may be generated using different types of controls than described above without departing from the scope of the claimed subject matter. Thus, the features of the update user interface 1500 described above with reference to FIG. 15 should be construed as exemplary and not limiting.

Returning to FIG. 14, at decision block 1416, the creation routine 1400 remains idle until an event directed at updating a draft voicemail message is received. For example, in one embodiment, controls available from the update user interface 1500 provide a way for a primary callee to input data that will be included in the draft voicemail message. In this regard, a control available from the update user interface 1500 may be activated that is either directed at inputting audio-based conversational data or contextual data that may be in any number of different formats including, but limited to, text, audio, and/or multimedia formats. Similar to the description provided above with reference to block 1406, when an event directed at updating a draft voicemail messages is received, the creation routine 1400 receives notice of the event along with a set of event data. In an alternative embodiment, the draft voicemail message is updated automatically. In this instance, the creation routine 1400 may interact with another software system to receive an electronic file that contains all of the information that will be sent to a secondary callee.

At decision block 1418, a determination is made regarding whether the event received at block 1416 is directed at inputting conversational data that will be included in the body of a voicemail message. In accordance with one embodiment, if the event was generated in response to the “RECORD” button 1508 being activated, then a determination is made that the event is directed at inputting conversational data and the creation routine 1400 proceeds to block 1420. Conversely, if the event is directed at providing contextual data that will be referenced in the metadata of the draft voicemail message, the creation routine 1400 proceeds to block 1424, described in further detail below.

As illustrated in FIG. 14, at block 1420 the creation routine 1400 obtains a stream of conversational data that will be included in the body of the draft voicemail message being created. As mentioned previously, when a control such as the “RECORD” button 1508 available from the update user interface 1500 is activated/deactivated, conversational data that will be included in the body of a voicemail message is captured using the audio system of a client device. However, it should be well understood that the body of a voicemail message may be input in other contexts. Moreover, any number of audio systems may be used by the creation routine 1400 to obtain the conversational data at block 1420. Then at block 1422, the stream of conversational data obtained at block 1420 is inserted into the electronic file, created at block 1410.

At block 1424, the creation routine 1400 modifies the metadata included with a voicemail message to reflect the input received from the primary callee. If block 1424 is reached, a determination was made, at block 1418, that the primary callee generated an event to modify the contextual data of the draft voicemail message. For example, while the update user interface 1500 is presented, a primary callee may generate an event to add/remove file attachments, change the secondary callee(s) who will receive the draft voicemail message, add/remove text in the subject line or other textbox, and the like. As mentioned previously, contextual data associated with a voicemail message may be defined in metadata. In accordance with one embodiment, the creation routine 1400 uses event data received at block 1418 to update a voicemail message's metadata to reflect the input that was received.

At decision block 1426, the creation routine 1400 determines whether additional conversational and/or contextual data will be obtained. In accordance with one exemplary embodiment, controls for recording the body of a voicemail message and providing contextual data may be accessed from the update user interface 1500. As mentioned previously, by interacting with the update user interface 1500, the body of a voicemail message may be recorded, paused, and played on demand. Moreover, a primary callee may modify the contextual data that is associated with the draft voicemail message. However, if the draft voicemail message is saved, communicated to a secondary callee, or the update user interface 1500 is closed, a determination is made at block 1426 that additional input will not be obtained. In this instance, the creation routine 1400 proceeds to block 1428, where it terminates. However, if additional conversational and/or contextual data may be obtained, the creation routine 1400 proceeds back to block 1414, and blocks 1414 through 1428 repeat if additional input is obtained.

While illustrative embodiments have been illustrated and described, it will be appreciated that various changes can be made therein without departing from the spirit and scope of the invention.

The embodiments of the invention in which an exclusive property or privilege is claimed are defined as follows:

1. A computer-readable medium containing computer-readable instructions which, when executed in a client device that receives a voicemail message over a digital voice communication environment, performs a method of generating a response to the received voicemail message, the method comprising:
providing a selection user interface where a primary callee may generate an event to create a draft voicemail message that is related to the received voicemail message;
in response to receiving an event to create a draft voicemail message:
creating an electronic file to store the draft voicemail message; and
inserting metadata into the electronic file that defines the relationship between the draft voicemail message and the received voicemail message.

2. The computer-readable medium as recited in claim 1, further comprising providing an update user interface where a primary callee may generate events to modify the draft voicemail message.

3. The computer-readable medium as recited in claim 2, wherein providing an update user interface where a primary callee may generate events to modify the draft voicemail message, includes:
receiving a stream of conversational data; and
updating the body of the draft voicemail message to reflect the input received.

4. The computer-readable medium as recited in claim 2, wherein providing an update user interface where a primary callee may generate events to modify the draft voicemail message includes:
receiving an event that describes a modification to the contextual data associated with the draft voicemail message; and
updating metadata included with the draft voicemail message to reflect the received event.

5. The computer-readable medium as recited in claim 1, wherein a control available from the selection user interface allows the primary callee to create a draft voicemail message that is a reply to the received voicemail message.

6. The computer-readable medium as recited in claim 1, wherein a control available from the selection user interface allows the primary callee to create a draft voicemail message that is a reply to all to the received voicemail message.

7. The computer-readable medium as recited in claim 1, wherein a control available from the selection user interface allows the primary callee to generate an event to create a draft voicemail message that is a forward to the received voicemail message.

8. The computer-readable medium as recited in claim 1, wherein a control available from the selection user interface allows the primary callee to:
identify a file by browsing a file system; and
add the file as an attachment to a transmission initiated from the selection user interface.

9. The computer-readable medium as recited in claim 1, wherein a control available from the selection user interface allows a primary callee to initiate a call using contextual data available from the received voicemail message.

10. The computer-readable medium as recited in claim 1, wherein a control available from the selection user interface allows the primary callee to send a file in response to the received voicemail message.

11. The computer-readable medium as recited in claim 1, wherein inserting metadata into the electronic file that defines the relationship between the draft voicemail message and the received voicemail message, includes;
extracting contextual data available from the received voicemail message; and
identifying fields in the draft voicemail message that may be populated with contextual data extracted from the received voicemail message.

12. In a digital voice communication environment that includes a client device configured to send and receive voicemail messages, a method of creating a draft voicemail message that is related to a received voicemail message, the method comprising:
receiving input to create a draft voicemail message;
wherein the input identifies a relationship between the draft voicemail message and the received voicemail message;
extracting contextual data from the received voicemail message; and
automatically populating the draft voicemail message with contextual data extracted from the received voicemail message.

13. The method as recited in claim 12, further comprising
obtaining the body of the draft voicemail message; and
communicating the draft voicemail message to a secondary callee.

14. The method as recited in claim 12, wherein the draft voicemail message is related to the received voicemail message as a reply, a reply to all, or forward.

15. The method as recited in claim 12, wherein extracting contextual data from the received voicemail message includes using a voice-recognition engine to convert audio in the body of the received voicemail message into text.

16. The method as recited in claim 12, wherein automatically populating the draft voicemail message with contextual data extracted from the received voicemail message, includes:
creating an electronic file to store the draft voicemail message;
identifying contextual data available from the received voicemail message that will be included in the draft voicemail message; and
inserting metadata into the electronic file to reflect the relationship between the draft voicemail message and the received voicemail message.

17. The method as recited in claim 12, wherein populating the draft voicemail message with the contextual data extracted from the received voicemail message includes providing an update user interface where a primary callee may generate an event to modify the draft voicemail message.

18. The method as recited in claim 17, further comprising:
receiving an event directed at updating the draft voicemail message;
determining whether the event is directed at updating the contextual data associated with the draft voicemail message; and
if the event is directed at updating the contextual data associated with the draft voicemail message, modifying metadata in the draft voicemail message to reflect the received event.

19. A computer-readable medium having computer executable components for generating a response to a received voicemail message, comprising:
a selection user interface component with selectable controls for creating a draft voicemail message that is related to the received voicemail message;
an update user interface component with selectable controls for modifying the draft voicemail message; and
a creation component operative to:
populate the draft voicemail message with data when a control for creating a draft voicemail message is activated from the selection user interface component; and
modify data associated with the draft voicemail message to reflect an event generated from the update user interface component.

20. The computer-readable medium as recited in claim 19, wherein the selection user interface component is further configured with a selectable control for generating a response to the received voicemail message by initiating a call.
